(19) United States
(12) Patent Application Publication
(10) Pub. No.: US 2013/0091044 A1
(43) Pub. Date: Apr. 11, 2013

(54) PAYMENT DEVICE WITH ACCOUNT IDENTIFIER

(71) Applicants: Sonia Reed, Danville, CA (US); Kenneth Sippola, San Francisco, CA (US); Julian Schmidt, Orinda, CA (US)

(72) Inventors: Sonia Reed, Danville, CA (US); Kenneth Sippola, San Francisco, CA (US); Julian Schmidt, Orinda, CA (US)

(21) Appl. No.: 13/648,142

(22) Filed: Oct. 9, 2012

Related U.S. Application Data
(60) Provisional application No. 61/545,504, filed on Oct. 10, 2011.

(51) Int. Cl. G06Q 20/34; G06K 19/06; G06K 19/077; G06K 19/00

(52) U.S. Cl. CPC G06Q 20/34; G06K 19/00; G06K 19/06196; G06K 19/07749
USPC 705/35; 235/487; 235/493; 235/492

(57) ABSTRACT

A payment device having identifying numbers configured in aligned segments in order to facilitate use of the payment device.

### CROSS-REFERENCE TO RELATED APPLICATIONS

This application is a non-provisional of and claims the benefit of the filing date of U.S. provisional application No. 61/545,504, filed on Oct. 10, 2011, which is herein incorporated by reference in its entirety for all purposes.

### BACKGROUND

Credit cards, debit cards, gift cards and even calling cards, often include a horizontal string of numbers that represents an account number such as a personal account number (PAN). This horizontal string of numbers is often difficult for a cardholder to remember, especially when, for example, the user purchases goods or services on a Website over the Internet.

Embodiments of the present invention address the aforementioned problem and other problems.

### BRIEF SUMMARY

Embodiments of the invention provide a payment device, such as a card, that has account number segments in a stacked relationship.

One embodiment of the invention is directed to a payment device comprising a substrate. A user element that is configured to identify a user of the payment device can be on the substrate. An account identifier is on the substrate and is divided into two or more segments on the substrate. The two or more segments can be in a stacked relationship. The payment device may also comprise an interface element configured to provide and store the account number.

Another embodiment of the invention is directed to an electronic device comprising a housing, a processor in the housing, and a display coupled to the processor. A graphical user interface is provided on the display, and an account number is displayed on the graphical user interface. The account number is divided into two or more segments that are in a stacked relationship.

In embodiments of the invention, the account number can include segments of equal size (e.g., 4 digits per segment), which are stacked on top of each other. In some embodiments, the stacked segments may be vertically aligned. This account number configuration can provide users of the payment device with a way to easily remember the entire number, e.g., through each segment, and a way to easily read the identifying number. It can also serve as an orientation mechanism for the user. For example, if the identification number is raised relative to other surfaces of the substrate, a user can feel where the numbers are and can locate the position of an interface such as a magnetic stripe. This can help a user orient his payment device quickly in case it is in his pocket and he wants to perform a payment transaction.

Embodiments of the invention can be described with reference to the Detailed Description and the drawings.

### BRIEF DESCRIPTION OF THE DRAWINGS

FIG. 1 illustrates an exemplary payment device in the form of a card having segmented identifying numbers in one embodiment.

FIG. 2(a) shows a front view of a payment device in the form of a card according to another embodiment of the invention.

FIG. 2(b) shows a rear view of the payment device shown in FIG. 2(a).

FIG. 2(c) shows a front view of a payment device according to another embodiment of the invention.

FIG. 3 illustrates an exemplary payment device in the form of a mobile phone having segmented identifying numbers in one embodiment.

FIG. 4(a) shows a block diagram illustrating elements in a mobile phone.

FIG. 4(b) shows a schematic illustration of some components of a payment card.

FIG. 5 shows a block diagram of a computer apparatus.

### DETAILED DESCRIPTION

Embodiments of the present invention provide a payment device having an account number configured to facilitate use of the payment device. The payment device can also include one or more user elements (e.g., user information) identifying the user. Examples of user elements may include a name, a signature and/or a photograph of the user.

The payment device may have an account identifier on a substrate. For example, the account identifier may comprise a primary account number (PAN) that is issued by an issuer and that is associated with the user of the payment device. Additionally, the payment device can also include an interface element that can store the account identifier and provide it to an external device such as a POS (point of sale) terminal. Examples of interface elements may include a magnetic stripe or a contactless element such as an RF antenna coupled to an integrated circuit (IC) chip.

If the account identifier is an account number, the numbers within the account number can be grouped into segments. The segments can have about the same length, and they can be arranged so that they are easily discernible from each other. For example, a 16-digit PAN on a credit card can be arranged in four segments, each segment including four numbers. Each segment can also be vertically-aligned and stacked such that the ordering of the segments is apparent. The segments can additionally be located proximate to the other segments such that all segments occupy a continuous region of the payment device.

Some descriptions of some terms may be useful to describe embodiments of the invention.

An “account identifier” may include a string of characters, and may be divided into segments. The segments may contain any suitable types of characters including letters and numbers. Such characters may be raised or embossed so that they can be felt by the user. In other embodiments, the characters maybe printed on the substrate and may be flat.

An “account number” of a payment device is an example of an account identifier and can include any number which is assigned to an account and/or a particular payment device. The account number can include a primary account number (PAN). The account number of a credit, debit or gift card can follow ISO/IEC 7812/7816 and ANSI X4.13 standards. The account number can include a BIN (bank identification number), encrypted values, and/or a check digit. In some cases, the account number may comprise exactly or about 14, 16, or 18 characters.

A “segment” may include a contiguous group, or block of characters (e.g., identifying numbers) that is a subset of characters within an account identifier. The characters may include numbers, letters, symbols, etc. A segment, may also include any suitable number of characters (or digits). For example, a segment may include 2, 3, 4, or even 5 characters. In some cases, each segment may comprise less than half of the characters in an identification string.

A “payment device” can refer, for example, to a credit card, debit card, gift card, phone card, or any other suitable device which is associated with a particular identifying number and can be utilized to conduct a transaction. Suitable physical payment devices may include a substrate, which is typically flat and made of plastic. Other examples of payment devices may include contactless phones, key fobs, etc.

An “electronic device” may comprise a device that can process data using a processor. Examples of electronic devices may include computer apparatuses such as laptop computers, mobile phones, tablet computers, etc. Electronic devices may be used to conduct purchase transactions, either at a point of sale or by contacting a remote server computer operating a Web site.

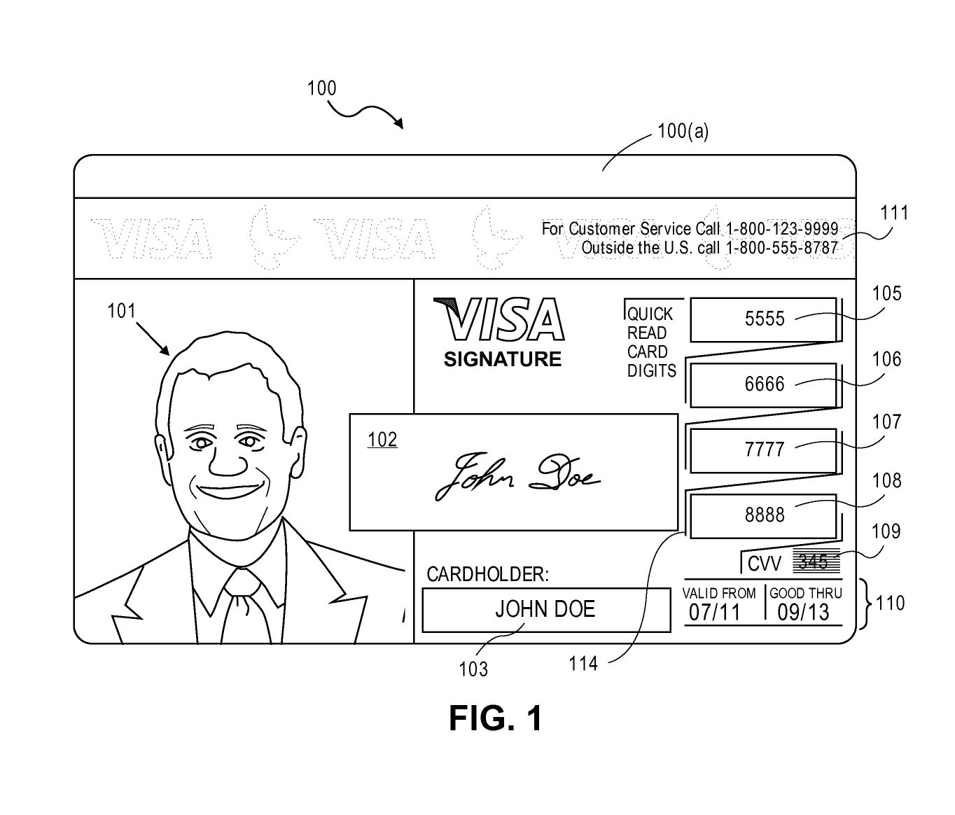

FIG. 1 shows an exemplary payment device in the form of a card 100. It has a segmented PAN. As shown, the card 100 can include various user elements on a substrate 100(a), such as a photograph 101 of the user (e.g., cardholder), a cardholder signature 102 and a printed name 103, validity dates 110, and a security code 109. The substrate 100(a) may be a planar body, and may have any suitable dimensions including dimensions less than about 4 inches by about 3 inches.

The substrate 100(a) may comprise any suitable material and may have any suitable thickness. Suitable substrates may comprise plastic, and may have more than one layer.

The card 100 may also comprise an interface element in the form of a magnetic stripe. The magnetic stripe 111 can store personal account numbers and security codes, along with other cardholder and issuer information. It can also communicate with a point of sale terminal.

Additional user elements such as the cardholder printed name 103 and cardholder signature 102 can be provided on the card 100 to validate the user of the card for additional security. The signature 102, though shown as centrally located, can be placed at any location on the card 100 (e.g., the front or back of the card). The signature 102 can overlap with the photograph 101 of the card 100 in some embodiments.

An account identifier can be divided and into two or more segments of digits. As shown in FIG. 1, the card 100 can include four segments of four digits each, which collectively form the account identifier which is 16 digits. The segments, which may comprise a first segment, a second segment, a third segment, and a fourth segment, can be in a stacked relationship and can be aligned. The first segment 105 can be four digits in length and can be located above (e.g., a distance furthest from the bottom edge of the card, relative to other segments) a second segment 106 of four digits. The second segment 106 can be located above a third segment 107 of four digits and the third segment 107 can be located above a fourth segment 108 of four digits. Accordingly, each of the four segments can be equal in length, e.g., four digits, and can be horizontally aligned along a vertical with each subsequent segment located below the prior segment.

In further embodiments, the identifying number segments can be oriented in any direction on the card 100. Additionally, the segments can be arranged on any continuous region of the card. For example, the stacked segments can be located on the right, central or left region of the card. In further embodiments, the segments are not horizontally aligned, e.g., the segments can be vertically aligned or diagonally aligned along a particular edge of the card. The segments can be aligned in any configuration which allows the order of the identifying number segments to be apparent.

One or more divider elements 114 may separate each adjacent pair of segments. The divider elements may be in the form of horizontal lines, diagonal lines, or may be in any other suitable form to help to visually delineate the separate the segments 105, 106, 107, 108. The divider elements 114 help a person visually identify and delineate the different segments 105, 106, 107, 108.

Referring again to FIG. 1, the card 100 can also include a security code segment 109, e.g. the CVV three digit number. The security code segment 109 can be aligned with the first, second, third, and fourth segments 106, 106, 107, 108, respectively, so that the user can easily remember and read the code. In some embodiments, the security code segment 109 is not proximate to, e.g., located within the same continuous region, as the first, second, third, and fourth segments 105, 106, 107, 108, respectively.

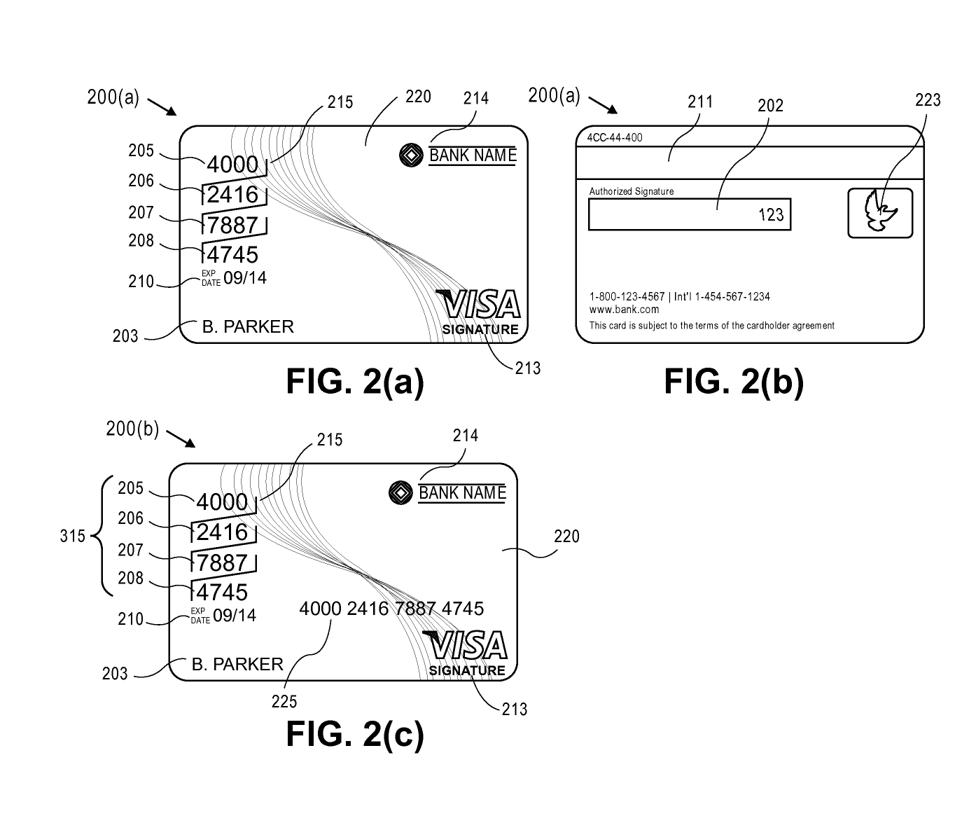

FIG. 2(a) shows a payment card 200(a) comprising a substrate 220. An account identifier comprising a first segment 105, a second segment 206, a third segment 207, and a fourth segment 208 are on the substrate 220, and are in a stacked relationship. Each segment can comprise four digits. Divider elements 215 can separate adjacent segments. The payment card 200(a) shown in FIG. 2(a) also comprises a name 203, expiration date 210, a payment processing organization logo 213, and an issuer name 214.

FIG. 2(b) shows the back of the card 200(a) shown in FIG. 2(a). The back of the card comprises a signature panel 202, as well as a hologram 223 and a magnetic stripe 211.

The embodiment in FIGS. 2(a) and 2(b) differs from the embodiment in FIG. 1. In FIG. 1, the magnetic stripe 111 is on the same side of the card as the account identifier. In FIGS. 2(a) and 2(b), the magnetic stripe 211 is on the opposite side of the card as the account identifier.

FIG. 2(c) shows a front surface of another payment card 200(b) according to an embodiment of the invention. In this example, a first linear account identifier 225 is present on the front of the card 200(b) along with a second account identifier 315 with stacked segments 205, 206, 207, 208. The first linear account identifier 225 may be embossed, while the second account identifier 315 may not be embossed, but may simply be printed on the substrate 220. The back of the card in FIG. 2(c) may be similar to that shown in FIG. 2(b).

The embodiment shown in FIG. 2(c) has advantages. For example, the linear account identifier 225 may be used with legacy card readers (e.g., those that imprint charge slips by running embossed numbers against carbon paper), while the second account identifier with the stacked segments can be used to help the user remember the account number, for example, for electronic purchases on the Internet.

Other embodiments are also possible. For example, although FIG. 2(c) shows a first account identifier with stacked segments and a second identifier with segments in a linear format on the same side of the card, it is possible to put the first and second identifiers on opposite sides of the card (e.g., the first account identifier on the front, and the second identifier on the back, and vice-versa).

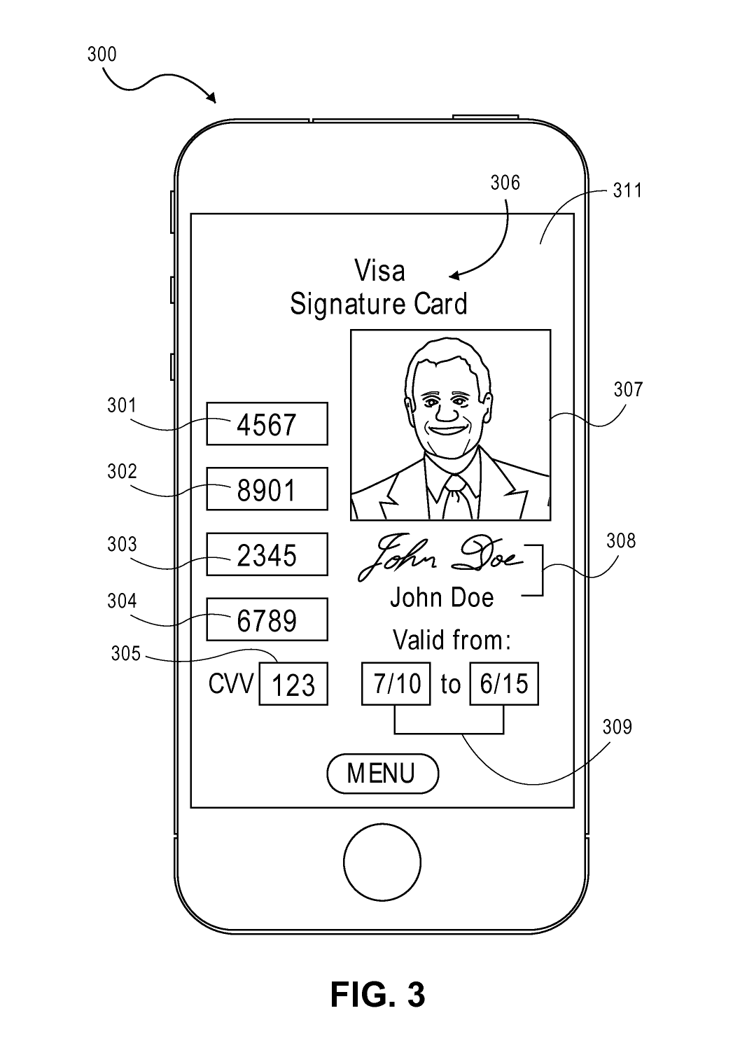

FIG. 3 shows an electronic device in the form of a mobile device 300. The mobile device 300 (e.g., mobile phone) has a graphical user interface (GUI) 311 for displaying the information associated with the payment device. The electronic device can include, for example, an application, which allows the user of the device (e.g., a cardholder) to access the account information. As shown, the GUI 311 can display information that is similar to the information on the card 100 in FIG. 1. The user can view the type card is being displayed, e.g., the card name “Visa Signature Card” 306 and the corresponding account identifier that is used to conduct a transaction.

The GUI 311 of the mobile device 300 can also display one or more user elements in order to verify the user of the electronic device. The user elements can include a photograph 307 of the user as well as a printed name and signature 308 of the user.

The GUI 311 can also display the account identifier, e.g., the PAN, in a similar format as shown in FIG. 1, such that the user of the mobile device 300 can easily read the stacked segments 301, 302, 303, 304. As shown in FIG. 3, a first segment “4567” 301 is located above a second segment “8901” 302, which is above a third segment “2345” 303 and a fourth segment “6789” 304. Though the aforementioned segments are shown aligned along the left side of the GUI, the stacked segments can be located anywhere within a continuous region on the GUI and may change locations dependent on the positioning of the mobile device 300.

A card verification value (CVV) “123” 305 can also be provided within the GUI 311. The CVV 305 is shown to be directly below the fourth segment 304.

However, the CVV 305 can be located in any location on the display of the GUI. Additionally, the validation dates “7/10 to 6/15 ” 309 can be provided to verify the valid usage of the displayed payment device information.

When the account number with the stacked segments is displayed on the GUI 311 on the display of the mobile phone 300, it may be present as a representation of a physical card. This may be useful when the mobile phone 300 is a contactless payment device that is used to conduct payments with a POS terminal. In other embodiments, the mobile phone 300 can be used to contact a remote server, which may operate a Web site. The Web site may have a Web page which may have data entry fields that correspond with the segments of the account identifier. For example, if an account identifier has four segments, with four characters in each segment, the Web page may have four windows so that the user may enter the four segments,

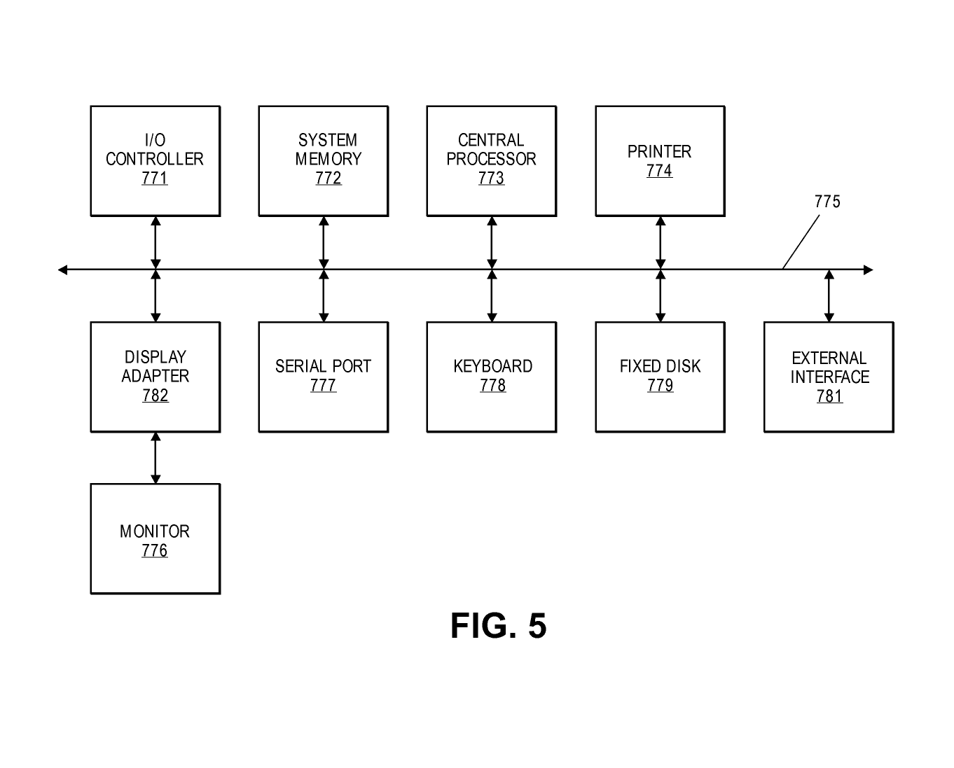

Although a mobile device is illustrated in FIG. 3, it is understood that the GUI with the account number with the stacked segments may be used on other electronic devices such as laptop computers. Components in such electronic devices can be found in at least FIG. 5.

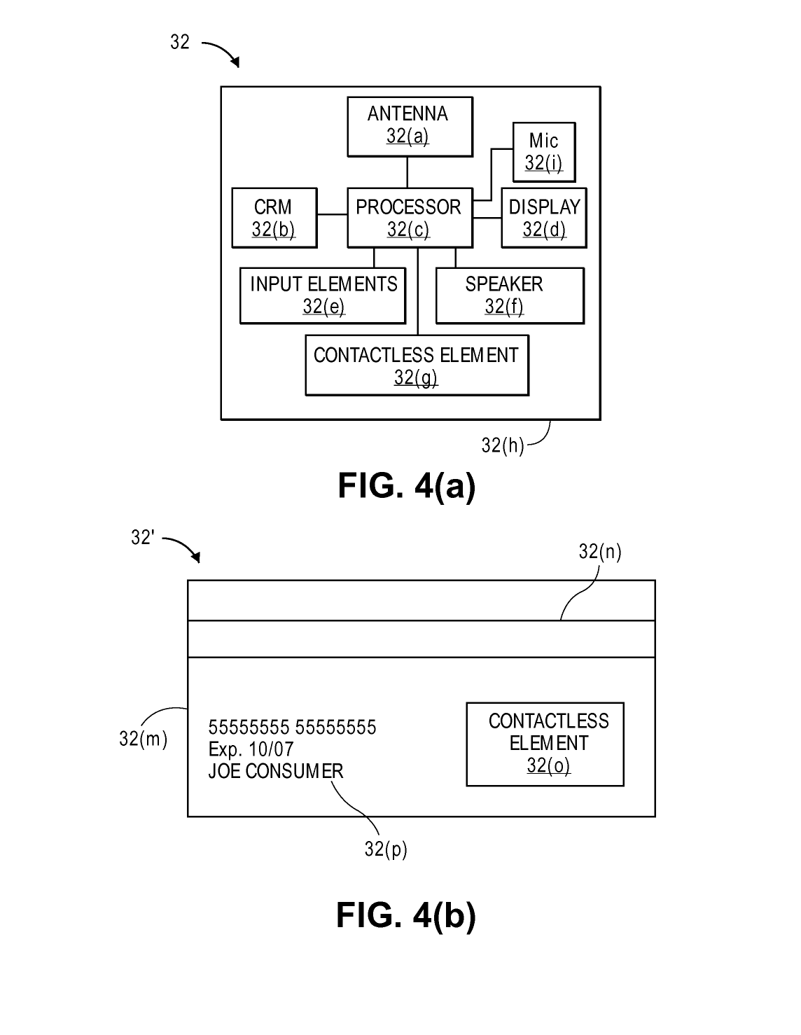

FIGS. 4(a), 4(b), and 5 show some function components of a mobile phone, payment card, and computer apparatus, respectively. The account identifier with the stacked segments can be provided on any one of the devices shown in FIGS. 4(a), 4(b), and 5.

An exemplary payment device 32 in the form of a phone may comprise a computer readable medium and a body as shown in FIG. 4(a). FIG. 4(a) shows a number of components, and the payment devices according to embodiments of the invention may comprise any suitable combination or subset of such components. The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the payment device 32.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used.

This is the track that is read by ATMs and credit card checkers. The ABA (American Banking Association) designed the specifications of this track and all world banks must abide by it. It contains the cardholder's account, encrypted PIN data, plus other discretionary data.

The payment device 32 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) payment device 32 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO/IEC 14443). Near field communications capability is a short-range communications capability, such as RFID, Bluetooth®, infrared, or other data transfer capability that can be used to exchange data between the payment device 32 and an interrogation device. Thus, the payment device 32 is capable of communicating and transferring data and/or control instructions via both cellular network and near field communications capability.

The payment device 32 may also include a processor 32(c) (e.g., a microprocessor) for processing the functions of the payment device 32 and a display 32(d) to allow a consumer to see phone numbers and other information and messages. The payment device 32 may further include input elements 32(e) to allow a consumer to input information into the device, a speaker 32(f) to allow the consumer to hear voice communication, music, etc., and a microphone 32(i) to allow the consumer to transmit her voice through the payment device 32. The payment device 32 may also include an antenna 32(a) for wireless data transfer (e.g., data transmission).

An example of a payment device 32′ in the form of a card is shown in FIG.

4(b). FIG, 4(b) shows a plastic substrate 32(m). A contactless element 32(o) for interlacing with an access device(not shown) may be present on or embedded within the plastic substrate 32(m). The contactless element 32(o) may comprise a memory chip, and an antenna coupled to the memory chip. Consumer information 32(p) such as an account number, expiration date, and consumer name may be printed or embossed on the card. Also, a magnetic stripe 32(n) may also be on the plastic substrate 32(m).

FIG. 5 shows typical components or subsystems of a computer apparatus, which can display the account identifier with the stacked segments. Additional subsystems such as a printer 774, keyboard 778, fixed disk 779, monitor 776, which is coupled to display adapter 782, and others are shown. Peripherals and input/output

(I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus 775 allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A payment device comprising:
a substrate;
a user element on the substrate, wherein the user element is configured to identify a user of the payment device;
an account identifier on the substrate, wherein the account identifier on the substrate is divided into two or more segments on the substrate, wherein the two or more segments are in a stacked relationship; and
an interface element configured to provide and store the account identifier.

2. The payment device of claim 1 wherein the account identifier is a first account identifier and wherein the payment device comprises a second account identifier with the two or more segments in a linear format.

3. The payment device of claim 1 wherein the account identifier comprising a bank identification number.

4. The payment device of claim 1 wherein the payment device is a payment card.

5. The payment device of claim 1 wherein the payment device is a credit card.

6. The payment device of claim 1 wherein the interface element is a magnetic stripe.

7. The payment device of claim 1 wherein the interface element comprises an antenna and a memory chip.

8. The payment device of claim 1 wherein the account identifier consists of four segments.

9. The payment device of claim 1 wherein the account identifier comprises exactly four segments, each segment having exactly four numbers.

10. The payment device of claim 1 further comprising one or more divider elements on the substrate, wherein at least one of the one or more divider elements is between adjacent segments.

11. The payment device of claim 1 wherein the interface element is on the same side of the payment device as the account identifier.

12. The payment device of claim 1 wherein the interface element is on the opposite side of the payment device as the account identifier.

13. An electronic device comprising:
a housing;
a processor in the housing;
a display coupled to the processor;
a graphical user interface provided on the display; and
an account identifier displayed on the graphical user interface, wherein the account identifier is divided into two or more segments that are in a stacked relationship.

14. The electronic device of claim 13 wherein the account identifier includes four segments, each having four digits.

15. The electronic device of claim 13 wherein the account identifier is a primary account number.

16. The electronic device of claim 13 wherein the two or more segments is four segments, each segment consisting of four characters.

17. The electronic device of claim 13 further comprising divider elements between adjacent segments in the two or more segments.

18. The electronic device of claim 13 wherein the electronic device is a computer apparatus.

19. The electronic device of claim 13 wherein the electronic device is a phone.

20. The electronic device of claim 19 wherein the phone comprises a contactless element.
